(19) United States
(12) Patent Application Publication
(10) Pub. No.: US 2023/0004120 A1
(43) Pub. Date: Jan. 5, 2023

(54) METHOD FOR ENCODING A DIGITAL HOLOGRAM, METHOD FOR ENCODING A GROUP OF DIGITAL HOLOGRAMS AND ASSOCIATED ENCODING DEVICE

(71) Applicant: FONDATION B-COM, Cesson Sevigne (FR)

(72) Inventors: Antonin GILLES, Rennes (FR); Patrick GIOIA, Servon-Sur-Vilaine (FR)

(21) Appl. No.: 17/784,009

(22) PCT Filed: Dec. 3, 2020
(86) PCT No.: PCT/EP2020/084547

§ 371 Date: Jun. 9, 2022

(30) Foreign Application Priority Data
Dec. 13, 2019 (FR) FR1914334

(51) Int. Cl. G03H 1/08; G06T 9/00; H04N 19/176; H04N 19/167

(52) U.S. Cl. CPC G03H 1/08; G06T 9/001; H04N 19/176; H04N 19/167

(57) ABSTRACT

A method for encoding a digital hologram represented by values associated respectively with pixels in a plane defining the digital hologram includes forming matrix blocks associated respectively with regions composed of contiguous pixels, each matrix block containing elements determined as a function of the values of the pixels in the region associated with the respective matrix block, applying to each of the matrix blocks a space-frequency transformation to obtain, for each matrix block, a set of coefficients respectively corresponding to different two-dimensional spatial frequencies within the respective matrix block, constructing two-dimensional structures each including coefficients from sets of coefficients and associated with two-dimensional spatial frequencies meeting a criterion that is dependent on the two-respective dimensional structure, and encoding the constructed two-dimensional structures.

### TECHNICAL FIELD OF THE INVENTION

The present invention relates to the technical field of digital holography.

In particular, it relates to a method for encoding a digital hologram, a method for encoding a group of digital holograms and an associated encoding device.

### STATE OF THE ART

The article “3D scanning-based compression technique for digital hologram video” by Y.-H. Seo, J.-J. Choi and D.-W. Kim in Signal Processing: Image Communication, vol. 22, no 2, pages 144-156, February 2007 describes a method for encoding a group of digital holograms comprising steps of segmenting each hologram into segments, applying a space-frequency transformation to each of the segments and scanning through the different segments for the encoding thereof.

This approach makes it possible to obtain a correct compression when the size of the blocks is low compared to the distance separating the scene represented by the hologram and the plane of definition of the hologram. Only in this case, in fact, will the transformed segments have redundancies between neighboring coefficients allowing efficient encoding.

### DISCLOSURE OF THE INVENTION

In this context, the present invention proposes a method for encoding a digital hologram represented by values respectively associated with pixels in a plane of definition of the digital hologram, comprises the following steps:
forming matrix blocks respectively associated with regions composed of contiguous pixels, each matrix block containing elements determined as a function of the values of the pixels in the region associated with the matrix block in question;
applying a space-frequency transformation to each of the matrix blocks so as to obtain, for each matrix block, a set of coefficients that respectively correspond to different two-dimensional spatial frequencies within the matrix block in question;
constructing a plurality of two-dimensional structures each comprising coefficients from a plurality of sets of coefficients and associated with two-dimensional spatial frequencies meeting a criterion that is dependent on the two-dimensional structure in question;
encoding the two-dimensional structures that have been constructed.

The reorganization of the coefficients within the different two-dimensional structures makes it possible to gather coefficients having a comparable meaning within the digital hologram, although initially located in distinct sets of coefficients. The encoding (which is applied to these two-dimensional structures) has therefore an improved efficiency.

Other non-limiting and advantageous features of the encoding method, taken individually or according to all the technically possible combinations, are the following:
the two-dimensional structures are constructed by grouping together, in each two-dimensional structure, the coefficients from said sets of coefficients and corresponding to a two-dimensional spatial frequency associated with the two-dimensional structure in question;
the two-dimensional structures are constructed by grouping together, in each two-dimensional structure, the coefficients from said sets of coefficients and corresponding to a two-dimensional range of two-dimensional spatial frequencies associated with the two-dimensional structure in question;
the regions are obtained by segmentation of said plane, the different elements of a matrix block being respectively the values of the pixels of the region associated with this matrix block;
the two-dimensional structures that have been constructed are encoded at least in part by means of an image encoding algorithm;
this image encoding algorithm takes as an input image a particular two-dimensional structure, or a matrix composed of the amplitude or the phase of the coefficients of a particular two-dimensional structure (and that, successively, for different two-dimensional structures);
the values of the pixels of the hologram are real;
the values of the pixels of the hologram are complex;
the coefficients in the two-dimensional structures being complex, the step of encoding the two-dimensional structures uses a first process of encoding the amplitude of said coefficients by means of an image encoding algorithm, and a second process of encoding the phase of said coefficients.

The invention also proposes a method for encoding a group of digital holograms, in which each digital hologram of said group is encoded by means of an encoding method such as that proposed hereinabove, and in which the different steps of encoding two-dimensional structures implemented during the different encoding methods are carried out in a predefined sequence within different digital holograms of said group.

The invention finally proposes a device for encoding a digital hologram represented by values respectively associated with pixels in a plane of definition of the digital hologram, said encoding device comprising:
a module for forming matrix blocks respectively associated with regions composed of contiguous pixels in such a way that each matrix block contains elements determined as a function of the values of the pixels in the region associated with the matrix block in question;
a module for applying a space-frequency transformation to each of the matrix blocks so as to obtain, for each matrix block, a set of coefficients respectively corresponding to different two-dimensional spatial frequencies within the matrix block in question;
a module for constructing a plurality of two-dimensional structures each comprising coefficients from a plurality of sets of coefficients and associated with two-dimensional spatial frequencies meeting a criterion that is dependent on the two-dimensional structure in question;
a module for encoding the two-dimensional structures that have been constructed.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limitative embodiments of the invention, and wherein:

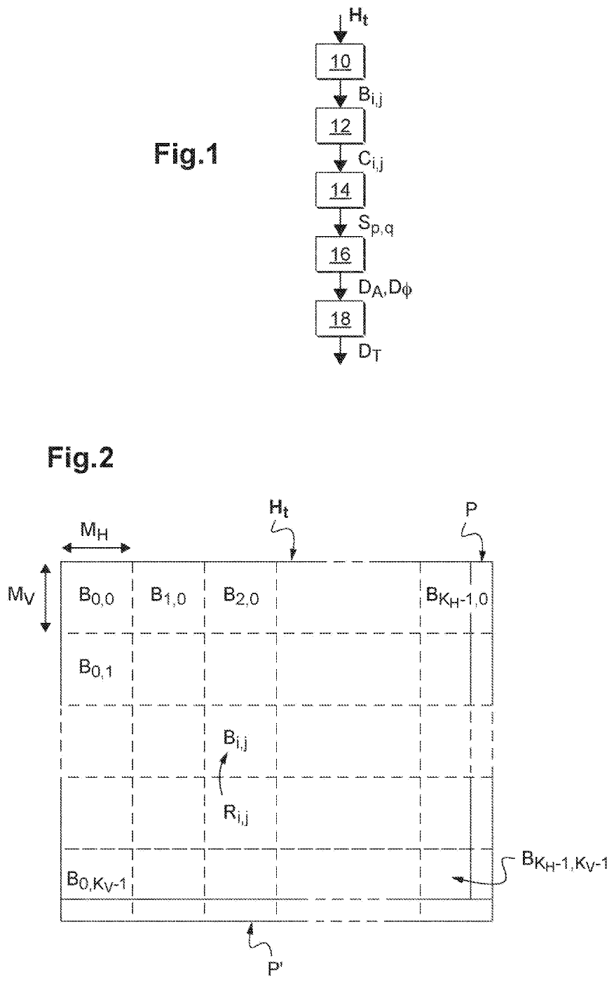

FIG. 1 schematically shows the main elements of an example of encoding device according to the invention;

FIG. 2 illustrates a possible example for the formation of matrix blocks within a digital hologram;

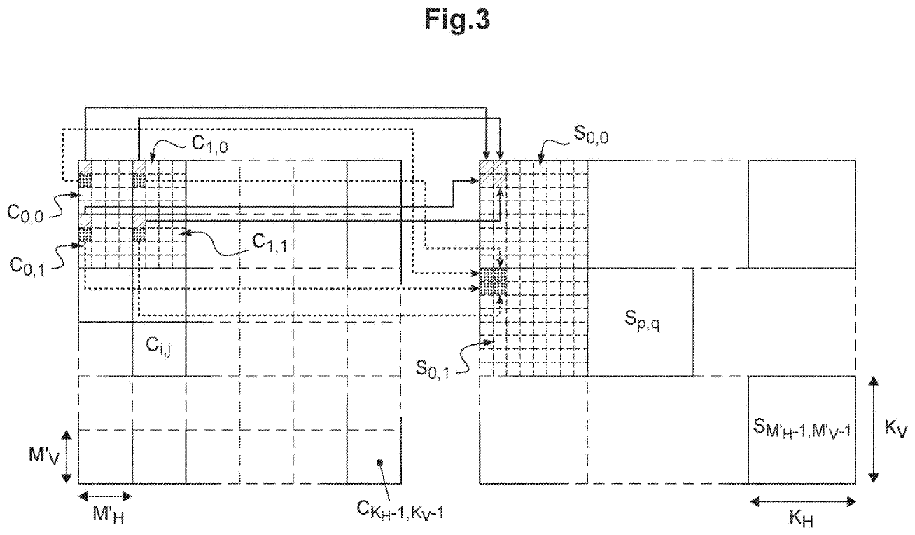

FIG. 3 illustrates the construction of two-dimensional structures from sets of coefficients;

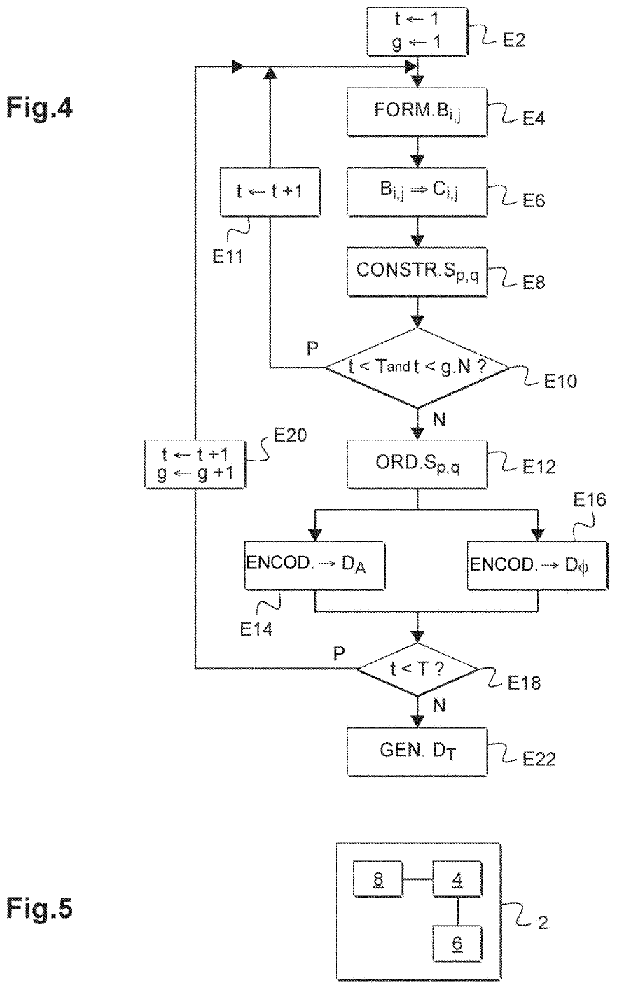

FIG. 4 is a flowchart showing the steps of an exemplary encoding method according to the invention; and

FIG. 5 shows the main elements of an example of an electronic device liable to form an encoding device according to the invention.

FIG. 1 shows the main elements of an example of encoding device according to the invention.

This encoding device comprises different modules 10, 12, 14, 16, 18 described hereinafter. This encoding device is for example implemented by means of a processor architecture, as described for example hereinafter with reference to FIG. 5. In such an architecture, the different modules 10, 12, 14, 16, 18 may each be made by cooperation of the processor with computer program instructions stored for example in a memory of the encoding device (such as the memory 6 of the electronic device 2 shown in FIG. 5) and designed to implement the functionalities of the module in question when they are executed by this processor.

Hereinafter will be described the encoding (by means of the encoding device) of a holographic video composed of a sequence of T digital holograms Hₜ (also called “frames of the holographic video”). The invention however also applies to the encoding of a single digital hologram H₁ (case in which T=1).

The digital holograms Hₜ are defined at one plane, each by means of values Hₜ(x,y) respectively associated with pixels, of position (x,y), distributed over two dimensions within an area (generally rectangular) of this plane of definition of the digital hologram Hₜ.

For a given digital hologram Hₜ, the value Hₜ(x,y) associated with a pixel (x,y) typically represents the light wave received, at this pixel (x,y), from a three-dimensional scene located on one side, or possibly on either side, of a plane of definition of the digital hologram Hₜ.

In the example described herein, the values Hₜ(x,y) are complex values and are hence represented (equivalently) either by a real part and an imaginary part, or by an amplitude (sometimes called norm or module) and a phase.

As an alternative, the values Hₜ(x,y) could be real values.

The values Hₜ(x,y) representing the digital holograms Hₜ of the sequence are for example stored in a memory of the encoding device (such as the memory 6 of the electronic device 2 given hereinafter as an example with reference to FIG. 5).

The encoding device comprises a module 10 for forming matrix blocks B_{i,j} from the values Hₜ(x,y) representing a given digital hologram Hₜ.

This module 10 is designed to form matrix blocks B_{i,j} respectively associated with regions R_{i,j} composed of contiguous pixels in such a way that each matrix block B_{i,j} contain elements B_{i,j}(a,b) determined as a function of the values Hₜ(x,y) of the pixels (x,y) of the region R_{i,j} associated with the block B_{i,j} in question.

In the example described herein, each matrix block B_{i,j} comprises M_{H} elements per line and M_{V} elements per column, determined as a function of values Hₜ(x,y) of pixels (the lines of the matrix blocks B_{i,j} here corresponding to the x-coordinates direction of the pixels in the plane of definition of the digital hologram Hₜ and the columns of the matrix blocks B_{i,j} here corresponding to the y-coordinates direction of these pixels).

In practice, the number M_{H} may be between 50 and 500 (M_{H} is for example equal to 64 or 128); likewise, the number M_{V} may be between 50 and 500 (M_{V} is for example equal to 64 or 128).

Moreover, as can also be seen in FIG. 2, module 10 is here designed in such a way as to form a matrix of K_{H}.K_{V} matrix blocks composed of K_{H} matrix blocks per line and K_{V} matrix blocks per column (i.e. composed of K_{V} lines and K_{H} columns). (In this matrix of matrix blocks, a matrix block B_{i,j} is located at line j+1 and column i+1.)

The encoding technique described herein is particularly interesting for processing digital holograms defined by a great number of pixels (typically higher than 10,000×10,000). In practice, each of the numbers K_{H} (number of matrix blocks B_{i,j} per line) and K_{V} (number of matrix blocks B_{i,j} per column) is for example higher than 500 (or even higher than 1000).

Module 10 determines for example each element B_{i,j}(a,b) of a matrix block B_{i,j} as follows:

B_{i,j}(a,b)=Hₜ(a+i·D_{H},b+j·D_{V})·w(a,b)

where D_{H} and D_{V} are two strictly positive integers lower than or equal to M_{H} and M_{V}, respectively, and where w is a matrix of real numbers of size M_{H}×M_{V}.

In a particular case possible, as shown in FIG. 2, the values D_{H}=M_{H}, D_{V}=M_{V} are taken, and all the elements w(a,b) of the matrix w are taken equal to 1: module 10 then forms the matrix blocks B_{i,j} by segmentation of the area in which the pixels are defined, in such a way that the different elements B_{i,j}(a,b) of a matrix block B_{i,j} are respectively the values Hₜ(x,y) of the pixels (x,y) of the region R_{i,j} associated with this matrix block B_{i,j}:

B_{i,j}(a,b)=Hₜ(a+i·M_{H},b+j·M_{V}).

As shown in FIG. 2 by the references P and P′, it is possible to complete the blocks B_{i,j} with zeros (operation generally called “padding”) when certain block elements B_{i,j} have no correspondent among the pixels defining the digital hologram Hₜ, for example because the dimensions of the digital hologram Hₜ are not multiple of M_{H} and M_{V} (respectively).

In other words, module 10 may set B_{i,j}(a,b)=0 when the coordinates (a+i.M_{H}, b+j.M_{V}) do not correspond to a pixel of the digital hologram Hₜ.

According to a possible embodiment, module 10 may form, in addition to the elements B_{i,j}(a,b) determined based on the values Hₜ(x,y) of the pixels (x,y), elements B_{i,j}(a′,b′) of zero value, in order to increase the number of elements in each matrix block B_{i,j} and hence the number of coefficients in each of the sets C_{i,j} described hereinafter. According to this possible embodiment: M_{H}<M′_{H} M_{V}<M′_{V} and B_{i,j}(a′,b′)=0 for a′ varying from M_{H}+1 to M′_{H} and for b′ varying from M_{V}+1 to M′_{V}.

At the exit of module 10, each matrix block B_{i,j} comprises M′_{V} lines and M′_{H} columns (with for example M′_{V} between 50 and 1000 and/or M′_{H} between 50 and 1000). (When the just-mentioned possibility to add elements of zero value to increase the number of elements is not used, then:

M_{H}=M′_{H} and M_{V}=M′_{V}·)

The encoding device also comprises a module 12 for applying a space-frequency transformation.

This module 12 is designed to apply this spatial-frequency transformation to each of the matrix blocks B_{i,j} in such a way as to obtain, for each matrix block B_{i,j}, a set C_{i,j} of coefficients C_{i,j}(k,l) respectively corresponding to different two-dimensional spatial frequencies (k, l) within the matrix block B_{i,j} in question.

It is understood by two-dimensional spatial frequency a couple of spatial frequencies respectively associated with two directions of space (here, the two directions, respectively along x-axis and y-axis, of the plane of definition of the digital hologram Hₜ).

The space-frequency transformation used is for example a two-dimensional Fourier transformation.

In this case, module 12 determines the coefficients C_{i,j}(k,l) of a set C_{i,j}, as follows:

$${C}_{i , j} ( k , l ) = γ {\sum }_{a = 1}^{{M}_{H}^{′}} {\sum }_{b = 1}^{{M}_{V}^{′}} {B}_{i , j} ( a , b ) \cdot {e}^{- 2 i π ( \frac{k \cdot a}{{M}_{H}^{′}} + \frac{l \cdot b}{{{M}_{V}^{′}}^{}} )} ,$$

where γ is a predefined constant.

Using a matrix organization based on that of the matrix block B_{i,j}, each set C_{i,j} of coefficients comprises M′_{V} lines and M′_{H} columns.

The encoding device moreover comprises a module 14 for constructing a plurality of two-dimensional structures S_{p,q}.

The construction module 14 is designed in such a way that each two-dimensional structure S_{p,q} constructed comprises coefficients C_{i,j}(k,l) from a plurality of sets C_{i,j} of coefficients and associated with two-dimensional spatial frequencies k, l meeting a criterion that is dependent on the two-dimensional structure S_{k,l} in question.

According to a possible embodiment, for a given two-dimensional structure S_{p,q}, the construction module 14 groups together in this given two-dimensional structure S_{p,q} the coefficients C_{i,j}(k,l) from all the sets C_{i,j} of coefficients and associated with a particular two-dimensional spatial frequency, of value (p,q).

As schematically shown in FIG. 3, by following within this given two-dimensional structure S_{p,q} an organization reproducing (within the above-mentioned block matrix B_{i,j}) that of the blocks B_{i,j} from which are derived the sets C_{i,j} of coefficients, a coefficient S_{p,q}(n,m) of this given two-dimensional structure S_{p,q} (coefficient located line n and column m in the two-dimensional structure S_{p,q}) is defined by:

S_{p,q}(n,m)=C_{n,m}(p,q).

According to this possible embodiment, the number of two-dimensional structures S_{p,q} constructed is thus equal to the number of coefficients C_{i,j}(k,l) per set of coefficients C_{i,j} (this number of coefficients C_{i,j}(k,l) per set of coefficients C_{i,j} being here equal to M′_{V}.M′_{H}).

Moreover, still within the framework of this possible embodiment, each two-dimensional structure S_{p,q} comprises a number of coefficients equal to the number of blocks B_{i,j} (in the above-mentioned block matrix B_{i,j} and that is clear from FIG. 2), i.e. here a number equal to K_{H}.K_{V}. Precisely, each two-dimensional structure S_{p,q} comprises a number of lines equal to the number (K_{V}) of lines in the block matrix B_{i,j} and a number of columns equal to the number (K_{H}) of columns in the block matrix B_{i,j}.

Other possible embodiments are conceivable to construct the two-dimensional structures S_{p,q}, as explained hereinafter.

The encoding device also comprises a module 16 for encoding the two-dimensional structures S_{p,q}.

This encoding module 16 is designed to order the two-dimensional structures S_{p,q} in a predefined order and to encode the coefficients S_{p,q}(n,m) of the ordered two-dimensional structures in order to obtain at least one sequence of data D_{A}, D_{ϕ}.

The encoding module 16 orders for example the two-dimensional structures S_{p,q} according to one of the methods contemplated in the article “3D scanning-based compression technique for digital hologram video” already mentioned for the ordering of the segments obtained by a discrete cosine transformation.

In the example described herein in which the coefficients S_{p,q}(n,m) contained in the two-dimensional structures S_{p,q} are complex numbers, the encoding module 16 encodes separately the amplitude of the coefficients S_{p,q}(n,m) and the phase of the coefficients S_{p,q}(n,m).

The encoding module 16 encodes for example the amplitude of the coefficients S_{p,q}(n,m) into a sequence of data D_{A} by means of an image encoding process such as those described in the MPEG-4 AVC standard, or in the MPEG-4 HEVC or MV-HEVC standard.

The encoding module 16 can encode the phase of the coefficients S_{p,q}(n,m) into a sequence of data D_{ϕ} by means of another encoding process, such as for example that described in the article “Phase-difference-based compression of phase-only holograms for holographic three-dimensional display”, by H. Gu et G. Jin, in Opt. Express, vol. 26, no 26, pp. 33592-33603, December 2018.

In the embodiments in which the coefficients S_{p,q}(n,m) contained in the two-dimensional structures S_{p,q} are real numbers, these coefficients can be encoded directly by an image encoding process (such as those mentioned hereinabove).

The encoding device finally comprises a module 18 for generating a flow of data to be transmitted (or binary flow) D_{T} on the basis of the encoded data produced by the encoding module 16. In an embodiment, the flow of data to be transmitted D_{T} (here for each group of digital holograms, as explained hereinabove) is generated by sequential combination of the sequence of data D_{A} and of the sequence of data D_{ϕ}. In other words, the sequences of data D_{A} and D_{ϕ} are sent one after the other to form the flow D_{T}, and that, successively for each group of N digital holograms Hₜ.

An example of encoding method, which may be implemented by the encoding device of FIG. 1, will now be described with reference to FIG. 4.

This encoding method is applied to a sequence of T digital holograms Hₜ organized into groups of N digital holograms. Each group of digital holograms hence comprise N digital holograms Hₜ that follow each other in the sequence of the T digital holograms.

The digital holograms Hₜ are for example stored in an memory of the encoding device of FIG. 1, as already indicated. The processing steps described hereinafter can also use this memory for storing the data obtained after each processing step (as well as the intermediate results).

The sequence of T digital holograms Hₜ (or frames) forms a holographic video.

The method of FIG. 4 starts with a step E2 in which a variable t and a variable g are initialized to the value 1. As will be evident from the following explanation, the variable t denotes the current digital hologram Hₜ (i.e. the digital hologram to which are applied the processing operations performed during the described steps) and the variable g denotes the current group of holograms.

The method of FIG. 4 continues at step E4, during which the encoding device (specifically here module 10) forms matrix blocks B_{i,j} respectively associated with regions R_{i,j} formed of contiguous pixels of the current hologram Hₜ, each matrix block B_{i,j} formed that way containing elements B_{i,j}(a,b) determined as a function of the values of the pixels of the region R_{i,j} associated with the block B_{i,j} in question.

As shown in FIG. 2, each region R_{i,j} here comprises M_{H} pixels in the horizontal direction (x-coordinates direction of the pixels) and M_{V} pixels in the vertical direction (y-coordinates direction of the pixels).

As indicated hereinabove, these elements B_{i,j}(a,b) determined as a function of pixel values are obtained, for example, (here by module 10) as follows:

B_{i,j}(a,b)=Hₜ(a+i·D_{H},b+j·D_{V})·w(a,b).

According to a possible embodiment, as already indicated, the matrix blocks B_{i,j} are obtained by segmentation of the current hologram Hₜ:

B_{i,j}(a,b)=Hₜ(a+i·D_{H},b+j·D_{V}), with D_{H}=M_{H} and D_{V}=M_{V}.

As indicated hereinabove, module 10 can potentially add elements B_{i,j}(a′,b′) of zero value within the matrix block B_{i,j}, in order in particular to increase the number of coefficients C_{i,j}(k,l) in each set C_{i,j}.

In the example described herein, as can be seen in FIG. 2, step E4 thus makes it possible to form K_{H}.K_{V} matrix blocks B_{i,j} organized as a matrix of K_{V} lines of matrix blocks B_{i,j} and K_{H} columns of matrix blocks B_{i,j}, each matrix block B_{i,j} itself comprising M′_{V} lines and M′_{H} columns. As explained hereinabove, the following values are for example used in practice: K_{H} higher than 500 (or even higher than 1000) and/or K_{V} higher than 500 (or even higher than 1000) and/or M′_{V} between 50 and 1000, and/or M′_{H} between 50 and 1000.

The method of FIG. 4 then comprises a step E6 of applying, to each of the matrix blocks B_{i,j} (taken separately), a space-frequency transformation in such a way as to obtain, for each matrix block B_{i,j}, a set C_{i,j} of coefficients C_{i,j}(k,l) that each respectively correspond to different two-dimensional spatial frequencies (k,l) within the matrix block B_{i,j} in question. This step is here implemented by the above-described module 12.

As already indicated, for each matrix block B_{i,j}, step E6 here comprises applying this space-frequency transformation (for example a two-dimensional Fourier transformation) to the set of elements of the matrix block B_{i,j} in question.

Therefore, step E6 here makes it possible to produce K_{H}.K_{V} sets C_{i,j} each comprising M′_{V}.M′_{H} coefficients C_{i,j}(k,l) respectively corresponding to M′_{V}.M′_{H} two-dimensional spatial frequencies (obtained by scanning through M′_{H} horizontal frequencies k and M′_{V} vertical frequencies I).

The method of FIG. 4 then comprises a step E8 of constructing a plurality of two-dimensional structures S_{p,q} each comprising coefficients C_{i,j}(k,l) from a plurality of sets of coefficients C_{i,j} and associated with two-dimensional spatial frequencies (k,l) meeting a criterion that is dependent on the two-dimensional structure S_{p,q} in question. This step E8 is here implemented by the construction module 14.

According to a first possible embodiment, the two-dimensional structures S_{p,q} are constructed at step E8 by grouping together, in each two-dimensional structure S_{p,q}, the coefficients C_{i,j}(k,l) from the sets of coefficients C_{i,j} and corresponding to a particular two-dimensional spatial frequency (k,l), associated with the two-dimensional structure S_{p,q} in question.

A given two-dimensional structure S_{p,q} thus groups together, in this case, coefficients C_{i,j}(k,l) representing the same two-dimensional spatial frequency (k,l).

In the case described hereinabove, step E8 hence makes it possible to construct M′_{H}.M′_{V} two-dimensional structures S_{p,q} each comprising K_{H}.K_{V} coefficients.

As shown in FIG. 3, it is further proposed herein to use, within each two-dimensional structure S_{p,q}, the matrix structure of the blocs B_{i,j} from which are derived the sets C_{i,j} providing the coefficients C_{i,j}(k,l) of the two-dimensional structure S_{p,q} in question, i.e. to define the coefficients S_{p,q}(n,m) of each block S_{p,q} by:

S_{p,q}(n,m)=C_{n,m}(p,q).

Each two-dimensional structure S_{p,q} formed that way has (as regards the amplitude of the coefficients) characteristics that are close to two-dimensional images that would have been obtained by parallel projection of the three-dimensional scene. The two-dimensional structures S_{p,q} thus have a shallow depth of field and strong spatial redundancies between adjacent coefficients within the two-dimensional structure, which allows the efficient encoding thereof at step E14 described hereinafter.

According to a second possible embodiment, the two-dimensional structures S_{p,q} are constructed at step E8 by grouping together, in each two-dimensional structure S_{p,q}, the coefficients C_{i,j}(k,l) from the different sets C_{i,j} of coefficients C_{i,j}(k,l) and corresponding to a two-dimensional range of two-dimensional spatial frequencies (k,l) associated with the two-dimensional structure S_{p,q} in question.

Therefore, in this case, different two-dimensional ranges of two-dimensional spatial frequencies are defined (each two-dimensional range covering for example a certain number, denoted hereinafter α.β, of different values of two-dimensional spatial frequencies represented within each set C_{i,j} of coefficients, where α and β are two integers such as α divides M′_{H} and β divides M′_{V}). A given two-dimensional structure S_{p,q} then groups together the C_{i,j}(k,l) from all the sets C_{i,j} and representing a two-dimensional spatial frequency (k,l) included in a particular two-dimensional range among these two-dimensional ranges. The coefficients S_{p,q}(n,m) of a two-dimensional structure S_{p,q} can in this case be given, for example, by:

S_{p,q}(n,m)=C_{E(n/α,E(m/β)}(p·α+n[α],q·β+m[β]),

where E(z) denotes the integer part of z, n[α] is the remainder of the Euclidian division of n by a and m[β] is the remainder of the Euclidian division of m by β.

In the case described hereinabove, step E8 hence makes it possible to construct M′_{H}.M′_{V}/(α.β) two-dimensional structures S_{p,q} each comprising α.ρ.K_{H}.K_{V} coefficients. The advantage of this embodiment is that it allows producing a less important number of two-dimensional structures S_{p,q}, the amplitude of the coefficients of which always has characteristics close to those which would have been obtained by parallel projection of the three-dimensional scene. By increasing the value of α and β, the number of two-dimensional structures S_{p,q} can be further reduced, at the cost of less spatial redundancy between adjacent coefficients within a same two-dimensional structure.

The method of FIG. 4 continues at step E10, during which the encoding device (here the processor thereof) determines if t<T and t<g.N.

The inequality t<T is valid as long as the last digital hologram H_{T} of the sequence of digital holograms has not been processed.

The inequality kg.N is valid as long as the last digital hologram Hₜ processed is not the last digital hologram of the current group of digital holograms (the index g indicating as mentioned hereinabove the current group).

In case of positive determination at step E10 (that is to say that the latter digital hologram Hₜ processed is neither the last of the sequence nor the last of a group), the method continues at step E11 by incrementation of the variable t denoting the current digital hologram Hₜ, then at step E4 described hereinabove for the processing of the new current digital hologram Hₜ.

In case of negative determination at step E10 (that is to say when the latter digital hologram Hₜ processed is either the last of the sequence or the last of a group), the encoding device (especially here the encoding module 16) orders, in a predefined order (or predefined sequence), the different two-dimensional structures S_{p,q} obtained (during the successive passages in step E8) for the different digital holograms of the current group (step E12).

As already indicated, the predefined order chosen is for example on the orders proposed in the article “3D scanning-based compression technique for digital hologram video” already mentioned for the ordering of the segments obtained by a discrete cosine transformation.

After implementation of step E12, an ordered sequence of two-dimensional structures S_{p,q} is obtained (the two-dimensional structures S_{p,q} of this ordered sequence coming from the processing of different digital holograms Hₜ of the current group; therefore, the ordered sequence of two-dimensional structures S_{p,q} comprises at least a first two-dimensional structure obtained by processing of a first digital hologram of the group and a second two-dimensional structure obtained by processing of a second digital hologram of the group).

The method of FIG. 4 then continues by the encoding of the so-ordered two-dimensional structures S_{p,q}, here by means, on the one hand, of encoding the amplitude of the coefficients present in the two-dimensional structures S_{p,q} (step E14) and, on the other hand, of encoding the phase of these coefficients (step E16).

Each two-dimensional structure S_{p,q} has a matrix shape identical to that of an image and each two-dimensional structure S_{p,q} can hence be encoded (in amplitude and/or in phase) by means of an image processing algorithm taking, as an input image of the algorithm, the two-dimensional structure in question.

This image processing algorithm may thus be applied successively to the different ordered two-dimensional structures (obtained at step E12), by taking successively, as an input image of the algorithm, a particular two-dimensional structure (or in practice a matrix formed of the respective amplitudes of the coefficients of this two-dimensional structure and/or a matrix formed of the respective phases of the coefficients of this two-dimensional structure).

Therefore, at step E14, the encoding module 16 applies successively an image encoding algorithm to different matrices each formed of different values of amplitude of the coefficients S_{p,q}(n,m) of a particular two-dimensional structure S_{p,q} (these matrices being taken in the order given to the two-dimensional structures S_{p,q} at step E12). The image encoding algorithm is for example an image encoding process such as those described in the MPEG-4 AVC standard, or in the MPEG-4 HEVC or MV-HEVC standard.

Step E14 thus makes it possible to obtain a sequence of data D_{A} participating to the encoding of the current group of holograms.

Comparably, at step E16, the encoding module 16 applies successively an encoding algorithm to different matrices each formed of the phase values of the coefficients S_{p,q}(n,m) of a particular two-dimensional structure S_{p,q} (these matrices being taken in the order given to the two-dimensional structures S_{p,q} at step E12). The encoding algorithm that is used is for example that described in the article “Phase-difference-based compression of phase-only holograms for holographic three-dimensional display”, by H. Gu et G. Jin, in Opt. Express, vol. 26, no 26, pp. 33592-33603, December 2018; the encoding algorithm that is used is thus here different from the image encoding algorithm used at step E14.

Step E16 thus makes it possible to obtain a sequence of data D_{ϕ} participating to the encoding of the current group of holograms.

The method of FIG. 4 continues at step E18 in which the encoding device (in practice the processor thereof) determines if t<T (that is to say checks that the digital hologram Hₜ processed at the last passage in steps E4 to E8 is not the last digital hologram H_{T} of the sequence).

In the affirmative (i.e. if it is determined that the last digital hologram Hₜ processed was not the last digital hologram H_{T} of the sequence), the method continues at step E20 for incrementation of the variable t denoting the current digital hologram Hₜ and of the variable g denoting the current group of digital holograms (the last digital hologram of a group having already been processed from the result of the previous passage in step E10).

The method then loops to step E4 for processing again the new group of digital holograms.

In the negative at step E18 (that is to say when the last digital hologram H_{T} of the sequence has been processed), the method continues at step E22 in which module 18 generates a flow of data D_{T} on the basis of the sequences of data D_{A}, D_{ϕ} respectively produced during the previous passages is steps E14 and E16 for the different groups of digital holograms processed.

For example, the flow of data D_{T} comprises a succession of several flows of data D_{GOH} each relating to a group of digital holograms, each flow of data D_{GOH} comprising successively the sequence of data D_{A} and the sequence of data D_{ϕ} determined as explained hereinabove for this group of digital holograms.

FIG. 5 describes an example of electronic device 2 liable to form an encoding device according to the invention.

This electronic device 2 comprises a processor 4 (for example, a microprocessor), at least one memory 6 and a telecommunication circuit 8.

The memory 6 can store computer program instructions designed to implement certain at least of the steps of the method of FIG. 4 when these instructions are executed by the processor 4.

The memory 6 (or potentially another memory) may further store, as already indicated, the values Hₜ(x,y) respectively associated with the pixels (x,y) to each define digital holograms Hₜ processed as explained hereinabove. The memory 6 (or potentially another memory) can then store the different values handled during the processing operations described hereinafter, in particular the elements B_{i,j}(a,b) of the matrix blocks B_{i,j}, the coefficients C_{i,j}(k,l) of the sets of coefficients C_{i,j}, the coefficients S_{p,q}(n,m) of the two-dimensional structures S_{p,q} and the data D_{A}, D_{ϕ}, D_{T}.

Finally, the telecommunication circuit 8 is designed to transmit (for example upon a command from the processor 4), typically to another electronic device (not shown), the flow of data D_{T} obtained at step E22.

1. A method for encoding a digital hologram represented by values respectively associated with pixels in a plane of definition of the digital hologram, the method comprising:
forming matrix blocks respectively associated with regions composed of contiguous pixels, each of the matrix blocks containing elements determined as a function of values of the pixels of the respective region associated with the respective matrix block;
applying a space-frequency transformation to each of the matrix blocks to obtain, for each of the matrix blocks, a set of coefficients respectively corresponding to different two-dimensional spatial frequencies within the respective matrix block;
constructing a plurality of two-dimensional structures, each of the plurality of two-dimensional structures comprising coefficients from a plurality of sets of coefficients and that respectively correspond with two-dimensional spatial frequencies meeting a criterion that is dependent on the respective two-dimensional structure; and
encoding the constructed two-dimensional structures.

2. The encoding method according to claim 1, wherein the constructed two-dimensional structures are constructed by grouping together, in each of the two-dimensional structures, the coefficients from said sets of coefficients that correspond to a two-dimensional spatial frequency associated with the respective two-dimensional structure.

3. The encoding method according to claim 1, wherein the constructed two-dimensional structures are constructed by grouping together, in each of the two-dimensional structures, the coefficients from said sets of coefficients that correspond to a two-dimensional range of spatial frequencies associated with the respective two-dimensional structure.

4. The encoding method according to claim 1, wherein the regions are obtained by segmenting said plane, the different elements of the respective matrix block respectively being the values of the pixels of the respective region associated with the respective matrix block.

5. The encoding method according to claim 1, wherein the constructed two-dimensional structures are at least partially encoded by an image encoding algorithm.

6. The encoding method according to claim 1, wherein the values of the pixels of the digital hologram are real.

7. The encoding method according to claim 1, wherein the values of the pixels of the digital hologram are complex.

8. The method according to claim 7, wherein the coefficients in the two-dimensional structures are complex, and
the encoding the constructed two-dimensional structures comprises encoding an amplitude of said coefficients by an image encoding algorithm, and
of encoding a phase of said coefficients.

9. A method for encoding a group of digital holograms, the method comprising:
encoding each of the digital holograms of said group by the encoding method according to claim 1,
wherein the encoding each of the constructed two-dimensional structures is carried out in a predefined sequence within the different digital holograms of said group.

10. A device for encoding a digital hologram represented by values respectively associated with pixels in a plane of definition of the digital hologram, said encoding device comprising:
one or more processors configured to
form matrix blocks respectively associated with regions composed of contiguous pixels such that each of the matrix blocks contain elements determined as a function of the values of the pixels in the respective region associated with the respective matrix block,
apply a space-frequency transformation to each of the matrix blocks to obtain, for each of the matrix blocks, a set of coefficients respectively corresponding to different two-dimensional spatial frequencies within the respective matrix block,
construct a plurality of two-dimensional structures, each of the plurality of two-dimensional structures comprising coefficients from a plurality of sets of coefficients and that respectively correspond with two-dimensional spatial frequencies meeting a criterion that is dependent on the respective two-dimensional structure, and in question;
encode the constructed two-dimensional structures.

11. The encoding method according to claim 2, wherein the regions are obtained by segmenting said plane, the different elements of the respective matrix block respectively being the values of the pixels of the respective region associated with the respective matrix block.

12. The encoding method according to claim 3, wherein the regions are obtained by segmenting said plane, the different elements of the respective matrix block respectively being the values of the pixels of the respective region associated with the respective matrix block.

13. The encoding method according to claim 4, wherein the regions are obtained by segmenting said plane, the different elements of the respective matrix block respectively being the values of the pixels of the respective region associated with the respective matrix block.

14. The encoding method according to claim 2, wherein the constructed two-dimensional structures are at least partially encoded by an image encoding algorithm.

15. The encoding method according to claim 3, wherein the constructed two-dimensional structures are at least partially encoded by an image encoding algorithm.

16. The encoding method according to claim 4, wherein the constructed two-dimensional structures are at least partially encoded by an image encoding algorithm.
